(19) United States
(12) Patent Application Publication
(10) Pub. No.: US 2006/0236374 A1
(43) Pub. Date: Oct. 19, 2006

(54) Industrial dynamic anomaly detection method and apparatus

(75) Inventor: Justin Hartman, Solon, OH (US)

Correspondence Address: ROCKWELL AUTOMATION, INC./(QB), ATTENTION: SUSAN M. DONAHUE, 1201 SOUTH SECOND STREET, MILWAUKEE, WI, 53204, US

(73) Assignee: Rockwell Automation Technologies, Inc.

(21) Appl. No.: 11/104,750

(22) Filed: Apr. 13, 2005

(51) Int. Cl. H04L 9/32

(52) U.S. Cl. 726/3

(57) ABSTRACT

A method and apparatus for identifying anomalies in an industrial enterprise, the method comprising the steps of during a commissioning procedure, operating the enterprise, monitoring enterprise communications, identifying characteristics of at least a subset of the monitored enterprise communications and storing at least a subset of the identified characteristics as allowed characteristics, after commissioning, using the stored allowed characteristics to identify enterprise communication anomalies that occur during enterprise operation.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention generally relates to industrial control systems, and more particularly to systems and methods that use communication and control profiles to dynamically detect, report, categorize, and classify communication anomalies and intrusions in an industrial networked control system.

Early industrial control systems for use in monitoring/controlling an industrial enterprise were developed assuming that the systems would be completely isolated from the outside world. Because early systems were typically isolated, security was not considered a particularly important issue and instead, design considerations included liveliness (i.e., known response times), safety and performance. To increase liveliness, safety and performance, industrial control devices utilizing ControlNet, DeviceNet, etc., and other robust control-specific networks have been developed along with a special Common Industrial Protocol (CIPs).

As Ethernet networks have become more ubiquitous in all environments including industrial facilities, designers have developed systems that allow users to remotely patch into industrial control networks via internet protocol (IP) communications for at least some purposes such as monitoring enterprise information, downloading operating parameters, etc.

While remote monitoring/control facilitates many new and useful applications, remote capabilities also result in security problems. For instance, where remote interfaces are useable to remotely access an industrial control network, an unscrupulous network hacker may be able to access the network and do many different things to either obtain system information or adversely/maliciously alter enterprise operations. For instance, a crafty hacker could access a programmable logic controller (PLC) within an enterprise and alter a control program, thereby causing a hazardous or life-threatening situation, or loss of product on the factory floor. In many cases, after a hacker determines how to remotely access a network, the hacker performs various discovery processes designed to yield information about enterprise and network configuration, protocols used on the network, etc. Here, discovery processes may include monitoring network activity or, in some cases, generating innocuous control signals and analyzing enterprise response.

To eliminate the possibility of hackers or unknowing and non-malicious intruders from accessing industrial networks, firewalls have been developed to isolate enterprises from larger networks such as the Internet or the like. To this end, as well known in the industry, firewalls are designed to intercept communications between devices located on one side of the firewall and enterprise resources on the other side of the firewall that are configured to perform an industrial process. Here, to access enterprise resources within the firewall, a user typically has to provide identifying information (e.g., a user name and password). Once a user's identity is verified, the user is allowed to access the enterprise network. In addition, even where a user is granted network access, in many cases a firewall is programmed to limit the types of activities that at least some users can perform. For instance, while a first user may be able to read sensor information, the firewall may restrict the first user from remotely altering machine operations by examining communications, identifying communications intended to alter machine operations and disallowing the operation-altering activities.

While firewalls are clearly a good idea and necessary in most applications that allow remote access, in many cases firewalls may be insufficient to achieve desired safety goals. The primary reason firewalls may fall short of desired expectations is that there are literally thousands of ways to exploit potential network vulnerabilities, and writing code to cover all of the ways to hack is generally impossible. In addition, network hackers are always developing new ways to gain access to network systems for malicious or other purposes and firewall code writers cannot anticipate tell tale signs of new hacking processes. Moreover, enterprise networks come in many different configurations and often include legacy components which means that often firewall code that is suitable for one configuration may not be ideal for another configuration.

Thus, it would be advantageous to have a method and apparatus that can identify hacker or intruder activities that occur on a network and more specifically within a firewall or on the enterprise side of a firewall. In addition, it would be advantageous if the method and apparatus were tailored for specific enterprise configurations so that hacker activity could be identified irrespective of specific network configuration characteristics.

### BRIEF SUMMARY OF THE INVENTION

It has been recognized that characteristics of enterprise-specific communications can be identified during a commissioning or learning process that can be used subsequently during normal enterprise operation to identify enterprise-specific communication anomalies. Once anomalies are identified, the anomalies can be used to perform any of several different secondary functions. For instance, in some cases an anomaly may cause notice of the anomaly to be given to a system user either in real time or on a periodic basis. As another instance, when an anomaly occurs, a server may halt transmission of an associated communication. In yet another instance, occurrence of an anomaly may lead to modification of firewall rules for a firewall that isolates an enterprise from larger computer/communication networks.

In at least some embodiments it has also been recognized that anomalies can be grouped into general category types in order to provide a practical system. To this end, it has been recognized that far too many unique anomalistic communications can occur on a typical enterprise network and therefore it would be impractical to attempt to specify specific secondary functions for each different possible anomaly. Instead, by specifying secondary functions for general anomaly types, a practical and yet useful system results. For instance, in one case general anomaly types may simply include internal (i.e., originating within an enterprise as opposed to remotely) read activities, internal write activities, external read activities, external write activities and a final type including all other internal and external activities. Other more detailed anomaly types and associated secondary functions are contemplated.

Thus, according to at least some embodiments of the present invention, characteristics of allowed enterprise communications can be identified by monitoring enterprise communications during a commissioning procedure. Thereafter, during normal operation of the enterprise, communications can be monitored and characterized and the communications can be compared to the allowed characteristics to identify anomalistic communications. When an anomaly is identified, a secondary function associated with the anomaly can be performed.

Consistent with the above, at least one embodiment of the invention includes a method for identifying anomalies in an industrial enterprise, the method comprising the steps of, during a commissioning procedure, operating the enterprise, monitoring enterprise communications, identifying characteristics of at least a subset of the monitored enterprise communications and storing at least a subset of the identified characteristics as allowed characteristics, after commissioning, operating the enterprise, monitoring enterprise communications, identifying characteristics of at least a subset of the monitored enterprise communications, comparing identified characteristics to allowed characteristics and, when an identified characteristic is different than the allowed characteristics, performing a secondary function.

In at least some cases the identified characteristics include at least a subset of communication protocol characteristics, activities associated with the communications and values expressed via the communications. In at least some cases the enterprise includes at least one interface, the method further including the steps of, during the commissioning procedure, via the interface, receiving input specifying at least a subset of user specified characteristics and storing the user specified characteristics as allowed characteristics.

In some embodiments the secondary function includes at least a subset of generating a notice of the identified characteristic, halting transfer of the communication associated with the identified characteristic and identifying the source of the communication associated with the identified characteristic. In some cases, when a communication source is identified, the method further includes requesting affirmation from the source that the communication was intended.

Some embodiments are for use with a firewall that applies firewall rules to limit communications of the enterprise wherein the secondary function includes altering firewall rules. Here, in some cases the step of altering the firewall rules includes changing the firewall rules so that communications including the identified characteristic are halted at the firewall.

In some embodiments the step of comparing includes identifying an anomaly when the identified characteristic is different than the allowed characteristics and wherein the method further includes the step of, prior to performing the secondary function, identifying the general type of anomaly that occurred and identifying a specific secondary function associated with the identified anomaly type. Here, in some cases the method further includes the step of providing an anomaly type/secondary function database that correlates general anomaly types with secondary functions and the steps of identifying the general type of anomaly and the secondary function include accessing the anomaly type/secondary function database.

In some cases the enterprise includes at least one interface, the method further including the steps of, during the commissioning procedure, via the interface, receiving input specifying at least a subset of user specified characteristics and storing the user specified characteristics as user specified anomalies.

In addition, some inventive embodiments include a method for configuring an enterprise to ignore communication anomalies where the enterprise includes at least one interface, the method comprising the steps of providing an allowed characteristic database that specifies characteristics of communications allowed on the enterprise, while the enterprise is operating, monitoring enterprise communications, identifying characteristics of the monitored communications, comparing the identified characteristics to the allowed characteristics, when an identified characteristic is different than the allowed characteristics, indicating the identified characteristic via the interface, via the interface, receiving an indication that the identified characteristic is an allowed characteristic and adding the identified characteristic to the allowed characteristic database.

Moreover, some embodiments include a method for identifying anomalies in an industrial enterprise, the method comprising the steps of during a commissioning procedure, operating the enterprise, monitoring enterprise communications, identifying characteristics of at least a subset of the monitored enterprise communications and storing at least a subset of the identified characteristics as allowed characteristics, after commissioning, using the stored allowed characteristics to identify enterprise communication anomalies that occur during enterprise operation. Here, the step of operating the enterprise may include simulating enterprise operations in software.

Furthermore, at least some inventive embodiments include a method for use with a firewall that applies firewall rules to limit communications on an enterprise network, the method for identifying anomalistic communications that occur within the enterprise and altering the firewall rules, the method comprising the steps of specifying allowed communication characteristics, operating the enterprise, monitoring enterprise communications, identifying characteristics of at least a subset of the monitored enterprise communications, comparing the identified characteristics to the allowed communication characteristics and when the identified characteristics are different than the allowed characteristics, altering the firewall rules.

Moreover, some embodiments include an apparatus for identifying anomalies in an industrial enterprise, the apparatus comprising a processor that is programmed to perform the steps of, during a commissioning procedure, operating the enterprise, monitoring enterprise communications, identifying characteristics of at least a subset of the monitored enterprise communications and storing at least a subset of the identified characteristics as allowed characteristics and after the commissioning procedure, using the stored allowed characteristics to identify enterprise communication anomalies that occur during enterprise operations.

### BRIEF DESCRIPTION OF THE SEVERAL VIEWS OF THE DRAWINGS

FIG. 1 is a schematic view of a system including a security/configuration server according to at least some aspects of the present invention;

FIG. 2 is a schematic view of an exemplary dual protocol data packet including a non-IP data packet embedded or encapsulated in an IP type data packet;

FIG. 3 is a simplified, albeit exemplary, communication characteristics database that is consistent with at least some aspects of the present invention;

FIG. 4 is a schematic illustrating an anomaly type/secondary function database that is consistent with at least some embodiments of the present invention;

FIG. 5 is a flow chart illustrating a commissioning and normal operating method performed by the server of FIG. 1 in at least some embodiments of the present invention;

FIG. 6 is a subprocess that may be substituted for a portion of the process illustrated in FIG. 5 according to at least one aspect of the present invention; and

FIG. 7 is an exemplary screen shot that may be provided via the interface of FIG. 1 that is consistent with at least some aspects of the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the term “device,” or “resource” is intended to refer to a computer-related entity, either hardware, a combination of hardware and software, software, or software in execution. For example, a device can be, but is not limited to, a process running on a processor, a processor, an object, an executable, a thread of execution, a program, a microprocessor, a processing unit and/or a computer, and hardware (e.g., a sensor or actuator) performing a process, etc.

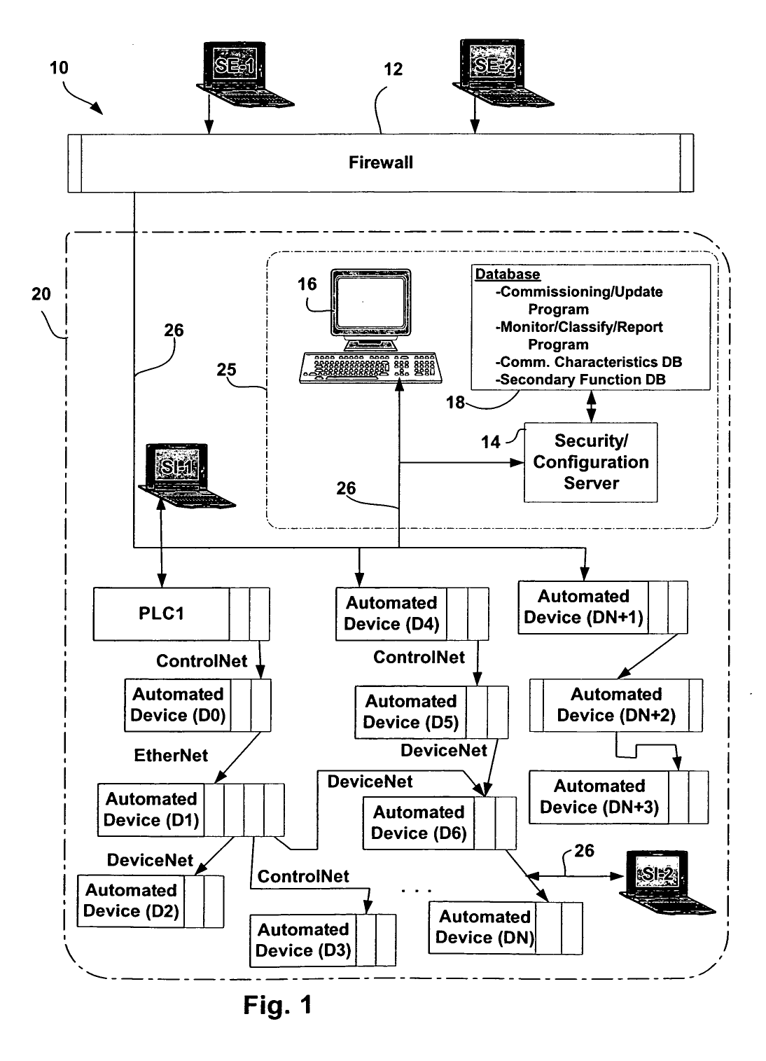

Referring now to FIG. 1, the present invention will be described in the context of an exemplary system 10 including an enterprise 20, a plurality of external sources, first and second exemplary sources identified by labels SE-1 and SE-2, respectively, and a firewall 12 that isolates enterprise 20 from the external sources SE-1 and SE-2. Exemplary enterprise 20 includes a security subsystem 25, internal source devices where exemplary first and second internal source devices are identified by labels SI-1 and SI-2, and an industrial control configuration including a plurality of industrial control devices such as programmable logic controller PLC1 and automated devices including devices D0, D1, D2, D3, etc. The industrial control devices (e.g., PLC1, devices D1, D2, etc.) are arranged in a manufacturing facility or the like to perform some industrial process. For example, the devices may be arranged to automatically assemble automobile seat components including cushions, springs, motors, rollers, support mechanisms, headrest extensions, covering material, etc. In this regard, in addition to PLCs to control other devices, devices may includes sensors, actuators, data collecting processors and devices, input/output concentrators, etc.

To facilitate control, monitoring exchange of data and configuring of the devices, the configuration devices are linked via a network collectively identified by numeral 26 as illustrated where network 26 includes, in the present example, both IP and non-IP components. For example, automated device D6 is linked to automated device D1, device D1 is linked to device D0 and device D0 is linked to PLC1. Similarly, device D6 is linked to device D5 and device D5 is linked to device D4. As illustrated, more than one device can be linked to another device. For instance, each of devices D2, D3 and D6 are linked to different output ports of device D1. Although only a small number of industrial control devices are illustrated in FIG. 1, it should be appreciated that, in many applications, several thousand devices may be linked together to form an intricate web of control components for facilitating complex industrial processes.

Each of the devices D0, D1, D2, etc. is assigned a specific network address and includes a processor capable of identifying network communications transmitted to the associated address. In addition, the device processors are programmed to examine received information packets to identify if the device is the final destination device or simply one device in a transmission path to some other destination device. Where the device is the final destination device, the processor uses packet data to perform some associated process. Where the device is not the final destination device, the processor transmits at least a portion of the received packet information to the next device in the transmission path.

As known in the automation industry, industrial control components may be of various network types, including, but not limited to, EtherNet, DeviceNet, ControlNet, etc. For instance, in FIG. 1, device D4 communicates with device D5 via ControlNet while device D5 communicates with device D6 via DeviceNet and device D1 communicates with device D2 via EtherNet. Also, as illustrated, one device may be capable of communicating in several different protocols, depending on the next device to which a packet is to be routed. For instance, device D1 communicates via a DeviceNet protocol with each of devices D2 and D6 but communicates via a ControlNet protocol with device D3.

In general, non-IP protocols are different than IPs in the way in which packets of information that facilitate the protocol are formed and the ways in which networked devices use the packet information to route to a final destination device. In this regard, while IPs typically specify a packet source and a destination device and rely on routers and switches to deliver information packets from a source to a destination device, non-IPs specify a specific network path through a chain of devices for delivering information packets from a source to a destination device. For example, referring once again to FIG. 1, to deliver a packet from firewall 12 to automated device DN, a non-IP packet may specify a path including device D4, device D5, device D6, and so on all the way through to device DN. Here, when device D4 receives the CIP packet, device D4 recognizes that the packet should be transmitted to device D5 and performs that transmission. Similarly, when device D5 receives the packet, device D5 determines that the packet should be transferred to device D6 and performs that transmission. This process continues until the packet is received by device DN. A second exemplary path through PCL1, and devices D0, D1, D6, etc. to device DN is illustrated. In FIG. 1, communications that originate outside enterprise 20 are IP communications and the network over which those communications travel is referred to as an IP network and communications that originate within enterprise 20 are referred to as non-IP communications (e.g., CIP communications, Data Highway Plus, etc.) and the network (not labeled) is referred to as a non-IP network.

Referring still to FIG. 1, each source SE-1, SE-2, IS-1, IS-2, etc., may include any type of component that may be used to attempt to access any of the industrial control components or devices included in enterprise 20. Here, the term “access” is used in a general sense to refer to the ability to monitor, control, configure and/or obtain information from a destination device. Exemplary sources SE-1, SI-2, etc., may include data monitoring and archiving servers, maintenance servers that analyze data obtained from system components and device other IP or non-IP networks including other devices, servers that perform control and safety operations with respect to system components and devices, etc.

In addition, at least some of the sources may include human-machine interfaces (HMIs) to enable authorized information technology personnel, maintenance personnel, an administrative person, etc., to access system devices and components. For example, illustrated sources SE-1 and SE-2 are laptop computers that run browser software to interact with laptop users to facilitate access to configuration devices. Other exemplary HMIs may include an electronic notepad, a personal computer, a palm pilot, a hand-held computer, a personal digital assistant, a mainframe computer, a cell phone, a “dumb” terminal, a tablet PC, etc. Hereinafter, laptop SE-1 will be referred to as HMI SE-1 and a person using HMI SE-1 will be referred to as a “user” unless indicated otherwise. Similarly, laptop SE-2 will be referred to as HMI SE-2 and laptops SI-1 and SI-2 will be referred to as HMIs SI-1 and SI-2, respectively. In addition, while any of the sources may-access or attempt to access enterprise devices either automatically (e.g., to periodically collect and archive operating data) or when a user performs some activating process, to simplify this explanation, access restriction will be described in the context of HMI SE-1 unless indicated otherwise. Moreover, while HMI SE-1 could be used to attempt to access any of the enterprise devices, unless indicated otherwise, the inventive concepts will be described in the context of activity that causes HMI SE-1 to attempt to access device DN via a path through devices D4, D5, D6, etc.

Referring still to FIG. 1, HMI SE-1 accesses control devices in enterprise 20 by forming and transmitting IP data packets via the IP based network that include information necessary to deliver the packets to the destination devices. To this end, because system 10 components between HMI SE-1 and a destination device within enterprise 20 communicate using both IP and non-IP, the data packet generated by HMI SE-1 to access an industrial control device must include information that facilitates both routing on the IP network to a device at the “edge” of the IP network and subsequent routing via the non-IP network between enterprise devices.

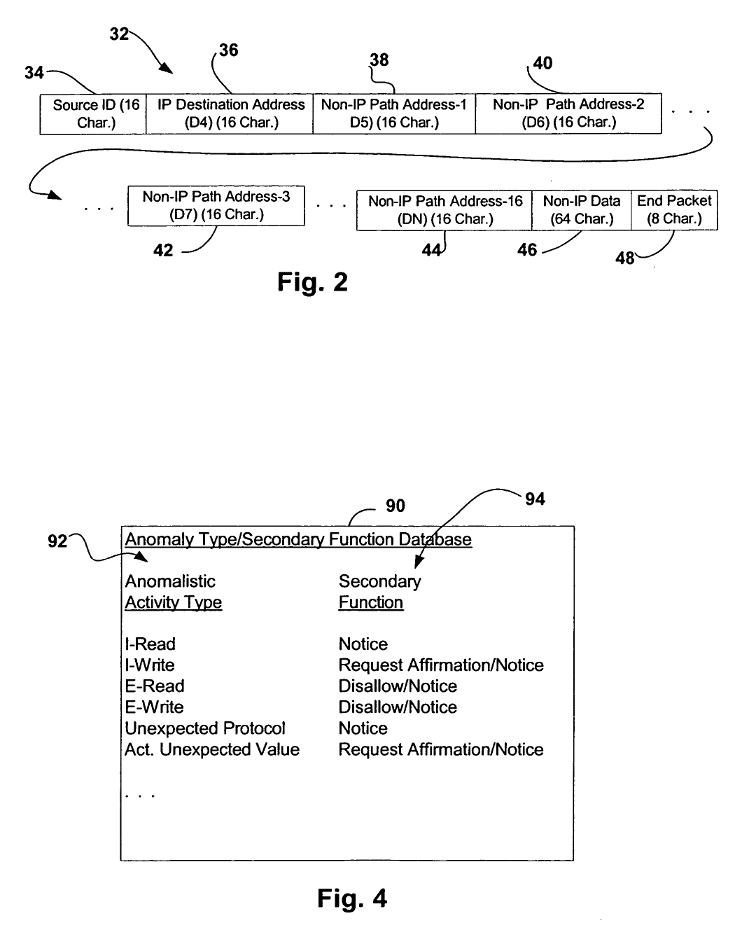

Referring now to FIG. 2, an exemplary data packet 32 that may be generated by HMI SE-1 in FIG. 1 to access one of the industrial control devices in enterprise 20 is illustrated. Exemplary packet 32 is a typical IP packet and, to that end, includes a frame that specifies packet source and destination device and a data field within the frame. In FIG. 2, the IP packet frame includes a source ID field 34 and an IP destination address field 36 as well as an end packet field 48. The IP packet data field includes fields 38, 40, 42, 44 and 46 as illustrated. As the label implies, source ID field 34 includes information that identifies the packet source. For example, referring again to FIG. 1, where HMI SE-1 generates a packet, the information in field 34 identifies HMI SE-1 as the source of the packet. Similarly, where source SE-2 generates a packet, field 34 identifies source SE-2 as the source of the packet.

IP destination address field 36 includes an address corresponding to a destination device for the IP packet where the destination device is at the edge of the IP network. Here, IP destination devices can only be devices that are directly linked to the IP network and that are capable of receiving IP packets. For example, referring again to FIG. 1, an exemplary IP target device linked to network may include device D4, device DN+1 or PLC1 while devices D1, D5, etc., that are not directly linked to the IP network are not capable of being IP target devices.

Referring still to FIG. 2, IP data field 49 is where data for delivery to a destination address is typically located. In the present case, a non-IP data packet is encapsulated in field 49 where the packet includes non-IP path device address fields 38, 40, 42 and 44 and a non-IP data field 46. The non-IP address fields 38, 40, 42 and 44 specify a string of addresses corresponding to non-IP devices and specify a path for non-IP routing. Data field 46 includes information that is to be delivered to the control device associated with the address specified in the last non-IP address field (e.g., field 44) of packet 32.

In addition to including specific field types and a specific order of field information, packet 32 also requires that each packet field have a specific length. For instance, as illustrated, source ID 34 field includes 16 characters, IP destination address field 36 requires 16 characters, non-IP data field 46 may include up to 64 characters, etc.

At this point it should be appreciated that communication protocols used in industrial applications can be extremely complicated and that precise protocol rules have to be followed to facilitate accurate communication. In addition, it should be appreciated that several protocols may be employed within a single system such as, for instance, both IP and non-IP protocols, (e.g., ControlNet, DeviceNet, EtherNetIP, etc.).

In at least some cases, it is contemplated that, while it may be advantageous to allow sources to access some of the industrial control devices within a system 10 and perform various activities with respect thereto, in at least some cases, it will be necessary to restrict access and activities of one or more of the sources. For instance, where HMI SE-1 is only used by maintenance personnel trained to analyze data associated with devices D4, D5, D6 through DN and to control those devices, it would be advantageous to restrict HMI SE-1 users so that HMI SE-1 cannot be used to access other system 10 devices (e.g., PLC1, devices D1, D2, etc.).

Referring again to FIG. 1, to restrict access to system devices according to one aspect of the present invention, firewall 12 is provided. Exemplary firewall 12 is provided within system 10 to isolate enterprise 20 from the external sources SE-1, SE-2, etc. Although not illustrated, in at least some embodiments it is contemplated that one or more additional firewalls may be included within enterprise 20 itself.

Referring once again to FIG. 1, security subsystem 25 includes a security/configuration server 14 that is linked to an HMI (e.g., a personal computer) 16 and a database 18 via network 26. Server 14 is used to perform several processes. First, during a commissioning procedure, server 14 is used to generate and store information regarding “allowed” communications/communication characteristics on enterprise 20. Second, after commissioning and during normal enterprise operation, server 14 is used to monitor characteristics of enterprise communications to identify communication anomalies (i.e., communications having characteristics that are “not allowed” or that are unexpected in light of the allowed information generated during the commissioning procedure). Hereinafter, unless indicated otherwise, characteristics of communications that are different than the “allowed” characteristics will be referred to as anomalies.

With respect to generating allowed communications information, referring again to FIG. 1, it has been recognized that after a specific enterprise is configured and programmed to perform an intended process, valid or allowed enterprise communications will each have characteristics that reflect the enterprise configuration and programs performed thereby. For instance, a data packet transmitted by HMI SE-1 to obtain a temperature reading from device DN will have to specify a non-IP transmission path that is valid given the configuration of enterprise 20. Where a packet seeks temperature information from device DN and specifies an invalid path, an unexpected anomaly occurs which may be a tell tale sign of a system error or, in at least some cases, an instance of an unauthorized enterprise intrusion by a system hacker or the like. As another example, referring again to FIG. 2, where packets 32 having the illustrated form are used to communicate on at least portions of network 26, where HMI SE-1 transmits a packet having a different form on the relevant portion of network 26, another anomaly occurs.

Exemplary communication characteristics of interest generally include three types although other types are contemplated. The three exemplary types of communication qualifying characteristics include protocol-related characteristics, activity-related characteristics and value-related characteristics. Protocol related characteristics include characteristics related to communication protocols used on network 26. For instance, exemplary protocol related characteristics include protocol formats (e.g., number of fields and types of information in the fields) and field lengths (e.g., 16 characters, 64 characters, etc.) for each protocol used on network 26.

Activity related characteristics include characteristics related to actions associated with communication packets and take two general forms. A first type of activity related characteristic is a routing characteristic that, in the context of a non-IP packet or portion of a packet, specifies a specific non-IP routing path. A second type of activity related characteristic is a destination function that, as the label implies, is related to a function to be performed by a destination device associated with a communication packet. For instance, destination functions may be to transmit sensor values back to a packet source device, to set an operating value or to clear a memory device.

Value related characteristics include values specified within a communication packet. For instance, exemplary communication packet values may include controller settings such as temperature, pressure, mixing speed, etc.

Hereinafter, unless indicated otherwise, the phrase “enterprise signature” will be used to refer to a communication on enterprise 20 that has characteristics (e.g., combination of protocol, activity and/or value related characteristics) that are consistent with the enterprise configuration and the process performed thereby. It should be appreciated that a single enterprise will have many different enterprise signatures, depending upon the protocols used by different portions of the enterprise, the activities performed by different devices within the enterprise and the values associated with the activities. For instance, referring again to FIG. 1, where device DN is a temperature sensor and device D4 is an actuator, one communication packet from PLC1 to device DN may specify a read temperature activity while another communication packet from PCL1 to device D4 may specify activation of the D4 actuator. In this example, because each of the PLC1-DN and PLC1-D4 communications is different, each will have a different enterprise signature (i.e., protocol-activity-value combination). In a typical enterprise it is contemplated that valid/allowed enterprise signatures may number in the tens of thousands or more.

While some embodiments may include enterprise signatures that include each of protocol, activity and value characteristics, in at least some cases it is contemplated that enterprise signatures may be based on one or only two of protocol, activity and value characteristics. Similarly, other characteristic types in addition to protocol, activity and value are contemplated in at least some embodiments.

To generate a list or database of allowed communication characteristics (e.g., enterprise signatures), according to at least one aspect of the present invention, referring again to FIG. 1, after enterprise 20 has been configured and programmed to perform a process and during a commissioning procedure, enterprise 20 is run to perform the intended process and server 14 monitors all or at least a subset of enterprise communications. During monitoring, server 14 identifies communication characteristics that occur and creates the allowed characteristics database. Here, the process of running enterprise 20 may include actually running the enterprise to perform the process or, in at least some cases, may include simulating the actual process in software or the like. The commissioning process includes performance of all foreseeable enterprise processes and subprocesses so that a substantially complete allowed characteristics database is created. For instance, internal sources (e.g., SI-1, SI-2, etc.) are used during the commissioning process to access information, write information, control devices, etc., if such activities are contemplated during normal operations. After an allowed characteristics database specific to enterprise 20 has been created and stored, normal enterprise operation can begin.

Referring once again to FIG. 1, to facilitate the commissioning process and the anomaly/intrusion identifying process that is performed during normal enterprise operation, database 18 includes a commissioning/update program, a monitor/classify/report program, a communication characteristics database, a secondary function database. As the label implies, the commissioning/update program includes code run by server 14 during the commissioning procedure described in greater detail below and that enables a system user to update the communication characteristics database after the commissioning procedure has been completed. The monitor/classify/report program includes code performed by server 14 after commissioning has been completed and during normal operation of enterprise 20 to identify communication anomalies, classify those anomalies and then perform some secondary function such as, reporting the anomaly to a system user or, in at least some cases, perform other activities such as disabling the source of communication, cutting off a communication from a target device, etc.

Referring still to FIG. 1 and also to FIG. 3, an exemplary, albeit simplified communication characteristics database 50 includes an auto-allowed database 51 and, in at least some cases, a user specified database 55. Auto-allowed database 51, as the label implies, includes enterprise signature information (i.e., allowed communication characteristics) that is automatically generated during the commissioning procedure. In contrast, user specified database 55 includes information regarding communication characteristics (both allowed and anomalistic) that is specified either during or after the commissioning procedure by a system user.

Auto-allowed database 51 includes three sub-databases including protocol database 30, an activities database 52 and a value range database 80. Referring again to FIG. 2 which illustrates exemplary data packet 32 having a specific form that may be used to communicate via enterprise 20, it is contemplated that in most configurations multiple communication protocols will be employed such as, for instance, pure IP type protocols, hybrid IP and non-IP protocols, different types of CIP protocols, etc. Referring also to FIG. 3, protocol database 30, as the label implies, specifies protocol format information for all protocols used within enterprise 20. To this end, database 30 includes a protocol type or identifier column 31 and a format column 33. Protocol type column 31 lists each of the protocols (e.g., P1, P2, etc.) allowed within enterprise 20. Format column 33 provides format information similar to the information illustrated in FIG. 2 for each of the protocols listed in column 31. The format information includes general information regarding numbers of allowed fields, field lengths, the types of information that should appear in fields, etc.

Referring still to FIG. 3, activities database 52 includes information automatically generated during the commissioning procedure that specifies allowed activities that may occur within enterprise 20 and that will be reflected in communication packets. To this end, exemplary and simplified database 52 includes three columns of correlated data, including a resource column 58, an activity column 60 and a target resource column 62. Resource column 58 lists each of the resources (e.g., POCs, devices, sensors, actuators, etc.) within enterprise 20. For example, exemplary resources in column 58 include PLC1, PLC2, device D0, etc. Activity column 60 lists a plurality of activity types associated with each of the resources in column 58. For example, with respect to resource PLC1 in column 58, column 60 lists a read activity, a write activity, a control-1 activity, a control-2 activity, etc. A read activity simply means that the associated resource in column 58 is capable of reading information from some subset of other enterprise resources. For example, referring once again to FIG. 1, device D0 may be capable of reading sensor information from device D1. A write activity in column 60 means that the associated resource in column 58 can write to at least a subset of the other enterprise resources. A control-1 activity in column 60 means that an associated resource in column 58 is capable of controlling at least a subset of other enterprise resources in a first fashion while a control-2 activity in column 60 means that an associated resource in column 58 can control at least a subset of the other enterprise resources in some second fashion.

Referring still to FIG. 3, target resource column 62 lists a subset of enterprise resources for each activity in column 60 for the associated resource in column 58. For example, an “all” designation in column 62 corresponding to the read activity in column 60 and PLC1 in column 58 indicates that PLC1 can read information from every resource within enterprise 20. Similarly, a list of devices (e.g., D-0, D-1, D-2, etc.) in column 62 corresponding to the write activity in column 60 and PLC1 in column 58 indicates that PLC1 can write to each of the devices in the subset list.

Value range database 80 lists controllable enterprise parameters and allowed value ranges for the controllable parameters. To this end, database 80 includes a resource column 82, a parameter column 84 and a range column 86. Resource column 82 lists all enterprise resources that have controllable parameters (e.g., temperature, pressure, rate of movement, etc.). For example, devices D0, D1, D2, etc., are listed in column 82. Parameter column 84 lists one and in some cases several parameters for each of the resources listed in column 84. For instance, both temperature T1 and pressure P1 are listed for device D0, pressure P2 is listed for device D1, etc. Range column 86 lists a value range for each parameter in column 84. For instance, a 15-18° celsius range is listed for temperature T1 in column 84. The value ranges in column 86 indicate allowed parameter values and can, in at least some embodiments, be determined during the commissioning process.

At this point it should be appreciated that auto-allowed database 52 is exemplary only. In the case of most enterprises, database 52 may include thousands or even tens of thousands of different communication characteristics and combinations thereof that are allowed within enterprise 20. Database 52 has been minimized in order to simplify this explanation and, in at least some cases, may include other more complex information such as timing limitations, order limitations (i.e., certain operations may not be able to be performed immediately (if ever) after certain other operationslimitations related to identity of specific HMI users or other source users, limitations related to other activity types, limitations that specify specific types of protocols that can be used to communicate between different pairs or subsets of enterprise resources, etc.

In at least some cases it is contemplated that, while server 14 may be able to generate a huge amount of information regarding allowed communication characteristics (e.g., enterprise signatures) during a commissioning procedure, a system user may still want to specify specific types of activities or communication characteristics that are either allowed or anomalistic. For example, a user may want to specify that no external HMIs (e.g., SE-1, SE-2, etc.) can be used to dump enterprise or controller data. As another example, a user may want to specify that no external source can be used to write to enterprise resources. To this end, in at least some embodiments, it is contemplated that the commissioning/update program will enable a system user to specify resources and associated anomalistic activities for monitoring.

Referring again to FIG. 3, exemplary user specified database 55 includes a user specified anomaly database 54. Database 54 includes two columns including a resource column 66 and an activity column 68. The resource column 66 lists separate system resources or subsets of resources while activity column 68 lists anomalistic activities for each of the resources in column 66. For example, resource column 66 includes two instances that specify all external sources via an SE-N entry. Activity column 68 indicates that none of the external sources as listed in column 66 can be used to dump enterprise data or to write to subset of enterprise resources including devices D6−DN+2, etc.

Referring still to FIG. 3, user specified database 55 also includes a user specified allowed characteristics database 56. Database 56 includes information provided by a system user that specifies allowed communication characteristics in addition to the characteristics automatically identified and specified in database 52. To this end, like database 52, exemplary database 56 includes a resource column 70, an activity column 72 and a target resource column 74. Information in columns 70, 72 and 74 is akin to information to columns 58, 60 and 62 described above and therefore, in the interest in simplifying this explanation, the information in column 70, 72 and 74 will not be described here. It should suffice to say that information in database 56 may be specified, in at least some cases, during a portion of the commissioning procedure and typically will be specified after automatic generation of information in database 52. In other cases, the information in database 56 may be specified subsequent to the commissioning procedure during some type of database updating process.

Although not illustrated, in at least some cases it is contemplated that the user specified database 55 illustrated in FIG. 3 would also include a separate user specified value range database akin to database 80 where, during a commissioning procedure, a user specifies the ranges of at least a sub-set of controllable parameters. Here, for instance, during commissioning, a list of controlled parameters and operating values (e.g., temperatures, pressures, etc.) may be provided to a user along with range selecting tools via interface 16 (see FIG. 1). Moreover, server 14 may be programmed to suggest typical ranges given values that occur during the commissioning process (e.g., ±3 degrees celsius from commissioning values). Moreover, in at least some cases a user may have to specify all parameter values and database 80 may be replaced by a similar database in database 55.

During normal operation, when a communication anomaly is identified, some activity associated therewith must be performed. For example, when an anomaly is identified, it may be desirable to provide notice to a system user or security personnel via interface 16. As another instance, it may be desirable for server 14 to disallow a particular communication. As another instance, it may be desirable for server 14 to require affirmation that a communication was meant to be performed. Other functions associated with anomalies are contemplated.

It has been recognized that, where anomalies are based on inability to match communication characteristics with allowed communication characteristics, it would be extremely difficult to specify specific functions to perform a response to each specific anomaly that occurs. In this regard, in a typical enterprise, there will be thousands of different specific anomalies that can and will occur during enterprise operation and therefore specifying anomaly specific related functions would be extremely burdensome and, in effect, impractical, as no one could identify all possible specific anomalies that would occur. For this reason, in at least some cases, it is contemplated that when an anomaly occurs, the anomaly may be identified as an instance (or one element of an instance where a type can be made up of a plurality of smaller specific parts) of a more general type or category of anomaly and secondary functions associated therewith may be type specific as opposed to anomaly specific. For example, whenever a communication is identified as an anomaly and the intended activity is to read information from an enterprise resource, if the source of the communication is internal, the secondary function associated with the anomaly may simply be to provide notice to a system user via interface 16. In the alternative, where an attempted communication is identified as an anomaly and the activity associated therewith is to read information from an enterprise resource but the source of the communication is external (e.g., SE-1, SE-2, etc.), the secondary function may be to disallow the read activity as well as to provide notice to a system user via interface 16. As another instance, where an internal source (e.g., SI-1) is used to attempt to write information to another enterprise resource, if an anomaly is identified, the secondary function associated with the anomaly may be to request affirmation of the write command from the internal source as well as to provide notice to a system user via interface 16. As still another instance, for an anomaly to be reported to a user, the anomaly may have to occur a number (e.g, 10) of times within a given period prior to reporting.

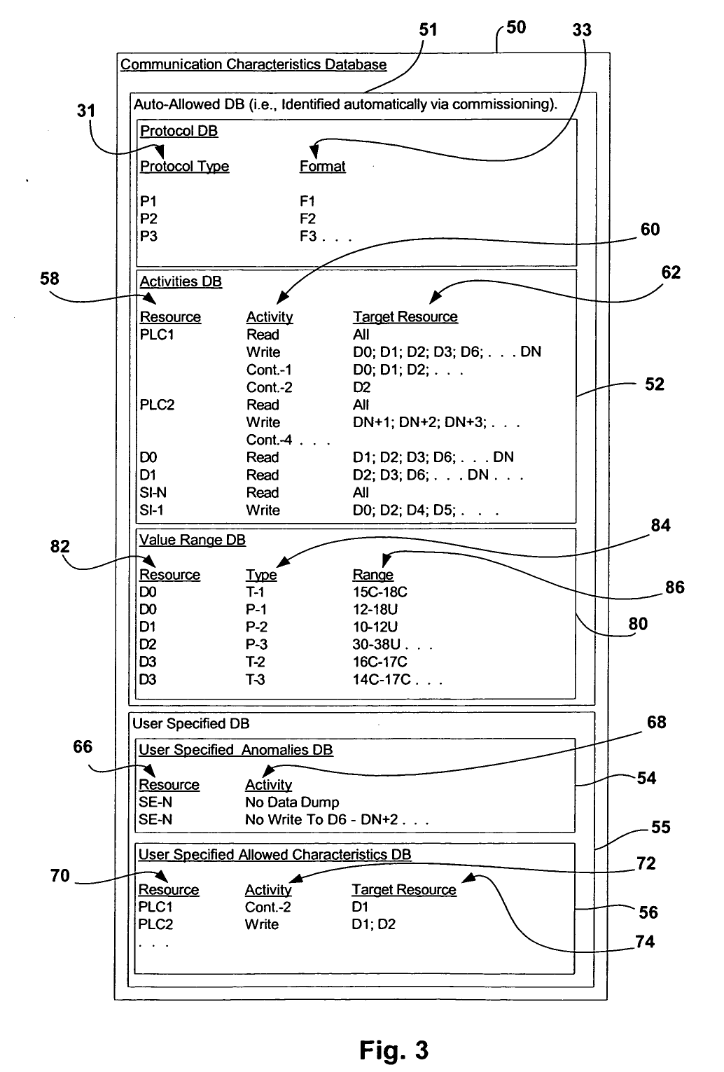

Referring now to FIG. 4, an exemplary secondary function database 90 is illustrated that includes two correlated columns of information including an anomalistic activity type column 92 and a secondary function column 94. Activity type column 92 lists general activity types that may be associated with anomalistic communications. Exemplary activity types in column 92 include an internal read, an internal write, an external read, an external write, an actuator unexpected value, an unexpected protocol, etc. Many other activity types are contemplated and have not been listed here in the interest of simplifying this explanation. Secondary function column 94 lists a separate secondary function associated with each of the activity types in column 92. For example, for the internal read activity type in column 92, column 94 includes a “notice” entry which indicates that, when an internal read anomalistic communication is identified, a notice is provided to a system user via interface 16 that an anomalistic internal read communication was attempted. Here, it is contemplated that the read activity would be performed subsequent to the notice being provided. The secondary function corresponding to an anomalistic internal write communication is a “request affirmation/notice” function wherein a request is provided to the source to affirm the write command and a notice is given to a system user via interface 16. Other secondary functions are listed in column 94 for the other activity types in column 92.

In at least some cases it is contemplated that notice will be provided to a system user via interface 16 essentially in real time when an anomalistic communication is identified. In the alternative, in at least some cases, notice of anomalistic communications may only be provided periodically such as, for example, at the beginning of a maintenance employee's shift. In other cases, it is contemplated that some notices may be provided to a user in real time while other less important notices may be provided in summary fashion and/or periodically. For example, notice of an anomalistic external write communication may be indicative of an attempted intrusion or hacker and in that case, real time notice may be provided while, an anomalistic internal read communication would be less likely to be indicative of an intruder or hacker and therefore notice could be provided on a periodic basis. As another example, where notices are periodically provided for review, notices of the same general type (e.g., unexpected protocols) may be summarized and provided in a summary fashion.

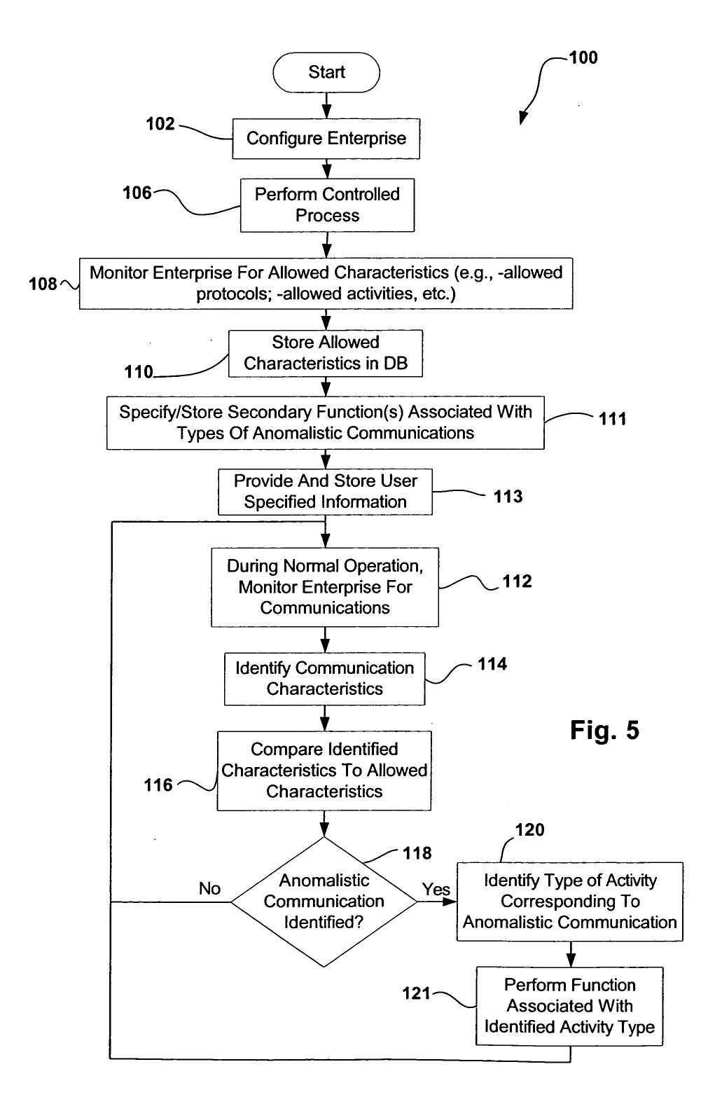

Referring now to FIG. 5, an exemplary method 100 consistent with at least some aspects of the present invention is illustrated. Referring also to FIG. 1, at block 102, enterprise 20 is configured and programmed to perform a process.

During a commissioning procedure, at block 106, enterprise 20 is run to perform the programmed process. At block 108, server 14 monitors enterprise 24 to identify communication information packets (see FIG. 2) of all types and examines the packets to identify communication characteristics including protocol, activity and value related characteristics thereby identifying enterprise signatures associated with the communications. One again, the enterprise signatures may take any of several different forms including allowed protocols, activities and/or values or combinations of protocols, activities and/or values (e.g., specific protocol types between specific enterprise resources, specific values associated with specific activities, etc.). At block 110, server 14 stores allowed characteristics in communication characteristics database 50 (see FIG. 3).

At block 111, secondary functions associated with the general activity types corresponding to expected anomalistic communication types are specified to form a secondary function database like database 90 illustrated in FIG. 4. Here, server 14 may simply be given access to database 90 where database 90 is prepackaged or prepared in advance. In the alternative, in at least some cases it is contemplated that a system user may be able to add activity types to or delete types from a database 90 or may be able to alter the secondary functions associated with activity types in database 90 using interface 16.

Referring to FIGS. 1 and 5, at block 113, a system user uses interface 116 to specify information in the user specified database 55. This process may take any of several different forms. For instance, some standard activities that are typically considered anomalistic may be prepackaged and provided to a system user via interface 16 to either be affirmed or affirmatively rendered allowed. As another instance, lists of enterprise resources and related activities may be provided for selection as allowed or anomalistic. As still one other instance, where a user at least in part specifies parameter value ranges to instantiate a value range database akin to database 80 in FIG. 3, values or ranges of values identified during process block 108 may be provided along with correlated parameter range setting tools (e.g., on-screen cursor selectable icons) for defining allowed ranges. After a user provides the user specified database information, that information is stored in database 55.

Referring still to FIGS. 1 and 5, during normal operation of enterprise 20, at block 112, server 14 monitors enterprise 20 to identify all or at least a subset of communications that occur thereon. At block 114, server 14 identifies communication characteristics that are of interest such as, for example, protocol, activity and value related characteristics. At block 116, server 14 compares the identified characteristics or combinations thereof to the allowed characteristics stored in database 50. At decision block 118, where only allowed characteristics are identified, control passes back up to block 112 where the loop including blocks 112, 114, 116 and 118 is repeated. At block 118, where an anomalistic characteristic is identified, control passes to block 120 where server 14 identifies the general type of activity corresponding to the anomalistic characteristic. For instance, server 14 may identify the activity type as an internal read type, an internal write type, an external read type, etc. After block 120, control passes to block 121 where server 14 performs the secondary function associated with the identified activity type. Referring once again to FIG. 4, for example, where the activity type associated with an occurrence of an anomalistic communication is an internal read type, server 14 provides notice to a system user via interface 16.

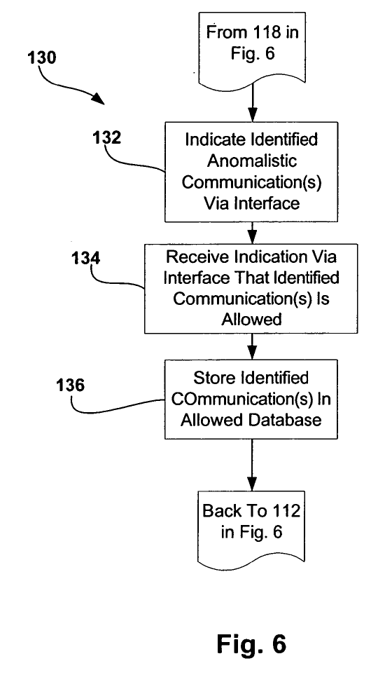

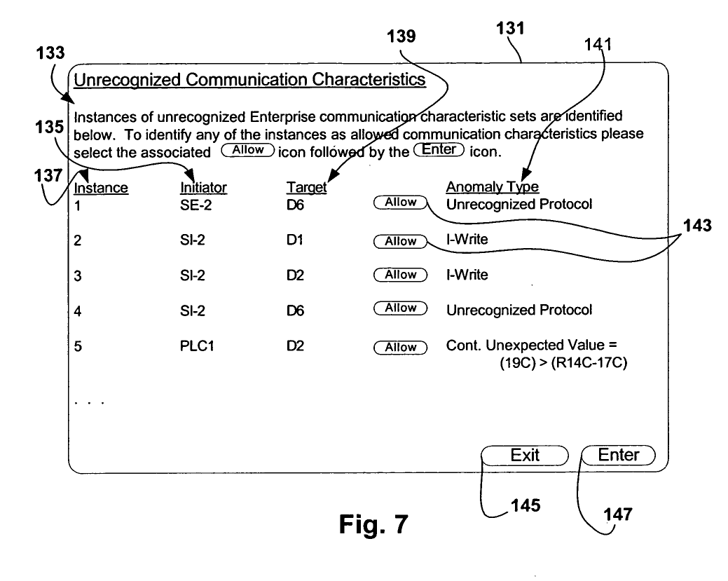

In at least some embodiments, it is contemplated that, when a system user receives notice of an anomalistic communication via interface 16, server 14 may provide tools via interface 16 enabling the user to indicate that in the future the anomalistic communication should be treated as allowed. To this end, a subprocess 130 that may be substituted for a portion of the process illustrated in FIG. 5 is shown in FIG. 6. Referring also to FIG. 7, an exemplary screen shot 131 that may be presented via interface 16 to enable a system user to manually indicate that an anomalistic communication should be considered is illustrated. Referring also to FIGS. 1 and 5, if an anomalistic communication is identified at block 118 in FIG. 5, control may pass to block 132 in FIG. 6. At block 132, anomalistic characteristics identified at block 118 are indicated via interface 16. In FIG. 7, exemplary screen shot 131 includes instructions 133 describing how a system user can indicate that specific communication characteristics should be considered allowed during subset system operation. In addition, screen shot 131 includes columns of associated information corresponding to specific communication characteristics including an instance column 137, an initiator column 135, a target column 139 and an anomaly column 141. Moreover, screen shot 131 includes cursor selectable icons including ALLOW icons, two of which are collectively identified by numeral 143, a EXIT icon 145 and an ENTER icon 147. Instance column 137 lists each anomalistic communication separately. Initiator column 135 lists a separate resource as the initiator of each instance in column 137. For example, for the first instance in column 137, column 135 indicates that HMI SE-2 was the initiator. Target column 139 lists a target enterprise resource for each of the instances in column 137. Anomaly type column 141 lists the type of activity corresponding to each instance in column 137. For example, an “unrecognized protocol” entry is provided in column 141 for the first instance in column 147. In addition, in at least some cases, other contextual information may be provided in column 141. For example, for instance five in column 137, the activity type in column 141 is listed as a controller unexpected value and then additional contextual information is provided which indicates that the value was 19° celsius which is a value outside of an expected range of between 14° and 17° celsius. This additional contextual information is intended to help the system user to determine whether or not the anomalistic communication should subsequently be identified as allowed.

As illustrated, a separate ALLOW icon is provided for each instance in column 137. Instructions 133 direct the system user to analyze the information presented in columns 137, 135, 139 and 141 and to select ALLOW icons 143 for any instances that should be allowed during future operation. Referring also to FIG. 6, at block 134, server 14 receives indications via interface 16 that specific characteristics identified via screen shot 131 should be considered allowed in the future. Here, indication includes selection of a subset of ALLOW icons 143 via screen shot 131 followed by selection of ENTER icon 147. In the event that the user does not want to manually identify any anomalistic communication characteristics as allowed for future use, the user can simply select icon EXIT 145.

Continuing, referring still to FIGS. 1 and 6, at block 136, server 14 stores the identified characteristic or characteristics in allowed database 50 (see FIG. 3).

While the invention may be susceptible to various modifications and alternative forms, specific embodiments have been shown by way of example in the drawings and have been described in detail herein. However, it should be understood that the invention is not intended to be limited to the particular forms disclosed. For example, while the present invention is described above in the context of a system where allowed communication characteristics include protocol, activity and value related characteristics, it should be appreciated that in at least some embodiments simplified characteristics subsets or, indeed, more complex characteristics subsets, are contemplated. For instance, in a very simple system, during the commissioning procedure, server 14 may simply identify all protocols and their corresponding characteristics used within the enterprise 20 to generate a simplified communication characteristics database 50 (see again FIG. 3). As another example, during a commissioning procedure, server 14 may only identify allowed activities and may not identify value ranges or protocol characteristics. In a more complex case, server 14 may identify different combinations of protocols, activities and/or value ranges.

In addition, while the method described above includes both a commissioning subprocess and a process that is performed during normal operation, in at least some cases it is contemplated that the commissioning subprocess or the normal operation process may be performed and may have certain separately inventive aspects.

Moreover, in at least some cases it is contemplated that, once anomalistic communications and communication characteristics have been identified, server 14 may be programmed to update rules applied by firewall 12 or other firewalls (not illustrated) that are provided within enterprise 20. Thus, the secondary function in at least some cases may be to alter firewall rules. Similarly, initial firewall rules may be developed at least in part by server 14 after a commissioning procedure has been performed. Similarly, a firewall processor (not illustrated) may be programmed to perform at least some if not all of the processes described above with respect to server 14.

Furthermore, it should be appreciated that while the above concepts have, for the most part, been described in the context of a system for limiting hacker access to an enterprise network, the present invention is also useful in the context of limiting non-malicious and even authorized network users from performing activities that they are not supposed to be performing. Thus, in addition to being able to prevent people with no rights from gaining access to a network and performing activities, the present invention also can be useful to restrict persons that have some network access authority so that they do not perform unauthorized activities.

Thus, the invention is to cover all modifications, equivalents, and alternatives falling within the spirit and scope of the invention as defined by the following appended claims.

To apprise the public of the scope of this invention, the following claims are made:

What is claimed is:

1. A method for identifying anomalies in an industrial enterprise, the method comprising the steps of:
during a commissioning procedure:
operating the enterprise;
monitoring enterprise communications;
identifying characteristics of at least a subset of the monitored enterprise communications; and
storing at least a subset of the identified characteristics as allowed characteristics;
after commissioning:
operating the enterprise;
monitoring enterprise communications;
identifying characteristics of at least a subset of the monitored enterprise communications;
comparing identified characteristics to allowed characteristics; and
when an identified characteristic is different than the allowed characteristics, performing a secondary function.

2. The method of claim 1 wherein the identified characteristics include at least a subset of communication protocol characteristics, activities associated with the communications and values expressed via the communications.

3. The method of claim 1 wherein the enterprise includes at least one interface, the method further including the steps of, during the commissioning procedure, via the interface, receiving input specifying at least a subset of user specified characteristics and storing the user specified characteristics as allowed characteristics.

4. The method of claim 1 wherein the secondary function includes at least a subset of generating a notice of the identified characteristic, halting transfer of the communication associated with the identified characteristic and identifying the source of the communication associated with the identified characteristic.

5. The method of claim 4 wherein, when a communication source is identified, the method further includes requesting affirmation from the source that the communication was intended.

6. The method of claim 1 for use with a firewall that applies firewall rules to limit communications of the enterprise wherein the secondary function includes altering firewall rules.

7. The method of claim 6 wherein the step of altering the firewall rules includes changing the firewall rules so that communications including the identified characteristic are halted at the firewall.

8. The method of claim 1 wherein the step of comparing includes identifying an anomaly when the identified characteristic is different than the allowed characteristics and wherein the method further includes the step of, prior to performing the secondary function, identifying the general type of anomaly that occurred and identifying a specific secondary function associated with the identified anomaly type.

9. The method of claim 8 further including the step of providing an anomaly type/secondary function database that correlates general anomaly types with secondary functions and wherein the steps of identifying the general type of anomaly and the secondary function include accessing the anomaly type/secondary function database.

10. The method of claim 1 wherein the enterprise includes at least one interface, the method further including the steps of, during the commissioning procedure, via the interface, receiving input specifying at least a subset of user specified characteristics and storing the user specified characteristics as user specified anomalies.

11. A method for configuring an enterprise to ignore communication anomalies where the enterprise includes at least one interface, the method comprising the steps of:
providing an allowed characteristic database that specifies characteristics of communications allowed on the enterprise;
while the enterprise is operating:
monitoring enterprise communications;
identifying characteristics of the monitored communications;
comparing the identified characteristics to the allowed characteristics;
when an identified characteristic is different than the allowed characteristics, indicating the identified characteristic via the interface;
via the interface, receiving an indication that the identified characteristic is an allowed characteristic; and
adding the identified characteristic to the allowed characteristic database.

12. The method of claim 11 wherein the identified characteristics include at least a subset of communication protocol characteristics, activities associated with the communications and values expressed via the communications.

13. The method of claim 11 for use with a firewall that applies firewall rules to limit communications on the enterprise, the method further including altering the firewall rules as a function of the received indication.

14. A method for identifying anomalies in an industrial enterprise, the method comprising the steps of:
during a commissioning procedure:
operating the enterprise;
monitoring enterprise communications;
identifying characteristics of at least a subset of the monitored enterprise communications; and
storing at least a subset of the identified characteristics as allowed characteristics;
after commissioning, using the stored allowed characteristics to identify enterprise communication anomalies that occur during enterprise operation.

15. The method of claim 14 wherein the step of operating the enterprise includes simulating enterprise operations in software.

16. The method of claim 14 wherein using the stored allowed characteristics to identify enterprise communications includes:
operating the enterprise;
monitoring enterprise communications;
identifying characteristics of at least a subset of the monitored enterprise communications;
comparing identified characteristics to allowed characteristics; and
when an identified characteristic is different than the allowed characteristics, performing a secondary function.

17. The method of claim 14 for use with a firewall that applies firewall rules to limit communications on the enterprise wherein, when an anomaly is identified, the method further including the step of altering the firewall rules.

18. A method for use with a firewall that applies firewall rules to limit communications on an enterprise network, the method for identifying anomalistic communications that occur within the enterprise and altering the firewall rules, the method comprising the steps of:
specifying allowed communication characteristics;
operating the enterprise;
monitoring enterprise communications;
identifying characteristics of at least a subset of the monitored enterprise communications;
comparing the identified characteristics to the allowed communication characteristics; and
when the identified characteristics are different than the allowed characteristics, altering the firewall rules.

19. The method of claim 18 wherein the step of altering the firewall rules includes changing the rules so that the firewall halts communications having the identified characteristics.

20. The method of claim 18 wherein the step of specifying allowed communication characteristics includes monitoring enterprise communication characteristics during a commissioning procedure and storing the characteristics for subsequent use.

21. An apparatus for identifying anomalies in an industrial enterprise, the apparatus comprising:
a processor that is programmed to perform the steps of:
during a commissioning procedure:
operating the enterprise;
monitoring enterprise communications;
identifying characteristics of at least a subset of the monitored enterprise communications; and
storing at least a subset of the identified characteristics as allowed characteristics; and
after the commissioning procedure, using the stored allowed characteristics to identify enterprise communication anomalies that occur during enterprise operations.
